(19) United States
(12) Patent Application Publication
(10) Pub. No.: US 2014/0083371 A1
(43) Pub. Date: Mar. 27, 2014

(54) Pet Leash

(71) Applicant: Amber McCrocklin, Tampa, FL (US)

(72) Inventor: Amber McCrocklin, Tampa, FL (US)

(21) Appl. No.: 13/624,829

(22) Filed: Sep. 21, 2012

(51) Int. Cl. A01K 27/00

(52) U.S. Cl. 119/795

(57) ABSTRACT

A pet leash comprised of a rope made of nylon, or any other suitable material. The rope is comprised on one end with a handle and on an opposing end with an o-ring. Between the handle and o-ring, a foam piece is provided which provides a cushion against the rope of the leash and the pet or animal. Between the handle and foam piece a sliding hook is located which allows the leash to connect to a pet's traditional collar, when the leash is worn by the animal. The hook slides on the rope of the leash and is easily moved along the rope to fit a variety of animals of varying shapes and sizes. When the pet or animal pulls on the leash, the sliding hook allows the leash rope to retract around the belly and also pulls the head back humanely stopping the animal.

### CROSS REFERENCE TO RELATED APPLICATIONS

This application claims priority from U.S. Patent Application Ser. No. 61/537,239 entitled “Pet Leash”, filed on Sep. 21, 2011. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a pet leash. More specifically, the present invention relates to a pet leash which provides a fast and humane way of controlling the pet.

### BACKGROUND OF THE INVENTION

There are a wide variety of pet leashes taught and known in the prior art. The simplest of these devices are collars which are buckled or tied around a dog's neck, and to which a leash is attached. Some of these collars are specifically designed to apply a choking pressure to a dog's neck when the leash is pulled. These are used in training to modify the dog's behavior.

In the prior art describing pet leashes, inventors have acknowledged the need to provide a pet restraint which does not bear down on the dog's sensitive neck area. Some leashes and harnesses have addressed this situation by providing devices which have straps under the dog's front legs, which apply pressure on the dog's front leg area when the leash is pulled back. Other leashes have a mechanism which squeezes the animal around the waist when the leash is pulled back. The problem with each of these devices is that it presents other problems. With a device which fits under the dog's under arm and pulls up on the front leg region, when a heavy and aggressive dog is restrained in this way, enough force is applied to his sensitive under arm area to damage ligaments located there. This is an undesirable side effect to be avoided. Gripping the dog around its midsection can also injure or strain the muscles of his underside, and cause the dog to vomit if enough pressure is placed there.

Other types of harnesses involve a strap which crosses from itself in front of a dog's chest, goes down the center line of the dog's belly and attaches back to a leash loop more or less between the dog's shoulders. This type of harness is improved over some harnesses, but still has the effect of choking the dog when the dog is restrained. This is especially true when the dog drops its head down and forward, such as to eat or drink, or to follow a scent on the ground.

Therefore, what is needed, is a pet leash that provides for control of a pet or animal in a humane way that minimizes the chances of these injurious side effects caused by leashes known and described in the prior art. What is desired is a pet leash that provides humane control of a pet that is quickly and easily attached and removed from the pet.

### SUMMARY OF THE INVENTION

The pet leash is comprised of a rope made of nylon, or any other suitable material. The rope is comprised on one end with a handle and on an opposing end with an o-ring. Between the handle and o-ring, a foam piece is provided which provides a cushion against the rope of the leash and the pet or animal. The foam piece prevents injury, rubbing, and similar injuries that could be result from wearing or over use of the leash. Between the handle and foam piece a sliding hook is located which allows the leash to connect to a pet's traditional collar, when the leash is worn by the animal. The hook slides on the rope of the leash and is easily moved along the rope to fit a variety of animals of varying shapes and sizes.

In use, the leash is placed onto the animal by first wrapping the rope portion containing the foam piece around the belly of the animal. Next, the handle and sliding hook are slid through the o-ring located at the opposing end. The sliding hook is then clipped on to the d-ring or other area of the pet's collar. A user can, and should, adjust the foam piece around the animals to reduce strain and minimize the change of injury to the animal. The leash works by retracting when the pet or animal pulls against it. When the pet or animal pulls on the leash, the sliding hook allows the leash rope to retract around the belly and also pulls the head back. The resulting pulling of the head in combination with the pressure of the tightening rope around its belly causes the animal to stop pulling quickly. The result is a fast and humane way of controlling and stopping the animal which greatly minimizes the potential for injury.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is a perspective view of the leash device of the present invention; and

FIG. 2 is a perspective view of the lease device of the present invention in use on a pet such as a dog.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

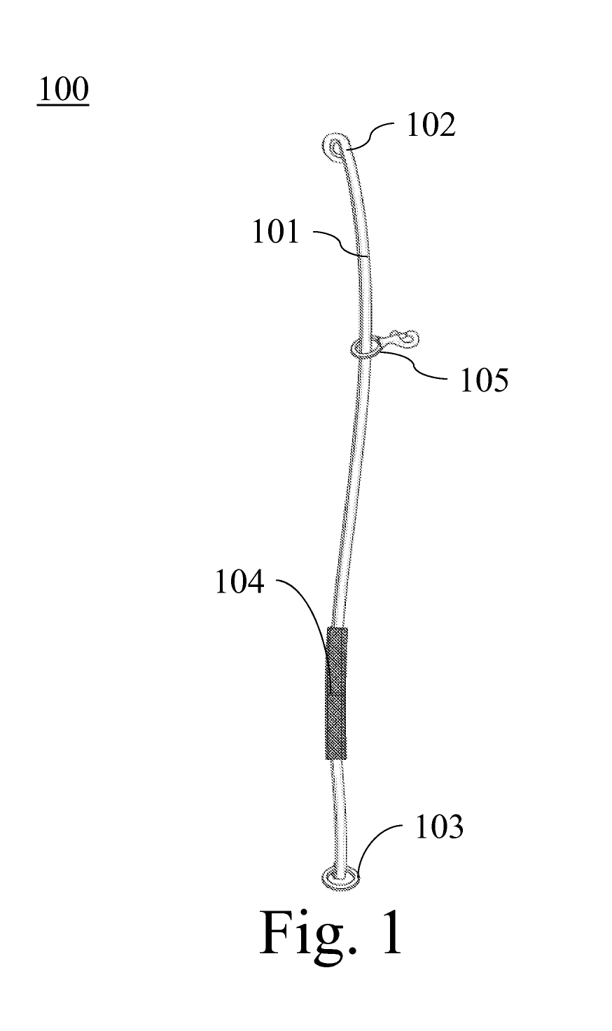

Now referring to the Figures, the embodiment of the pet leash taught by the present invention is shown. Now referring to FIG. 1, the pet leash 100 is comprised of a rope 101 made of nylon, or any other suitable material. The rope 100 is comprised on one end with a handle 102 and on an opposing end with an O-ring 103. Between the handle 102 and O-ring 103, a foam piece 104 is provided which provides a cushion against the rope 101 of the leash 100 and the pet or animal. The foam piece 104 prevents injury, rubbing, and similar injuries that could be result from wearing or over use of the leash 100. Between the handle 102 and foam piece 104 a sliding hook 105 is located which allows the leash 100 to connect to a pet's traditional collar 106, when the leash 100 is worn by the animal. The hook 105 slides on the rope 101 of the leash 100 and is easily moved along the rope 101 to fit a variety of animals of varying shapes and sizes.

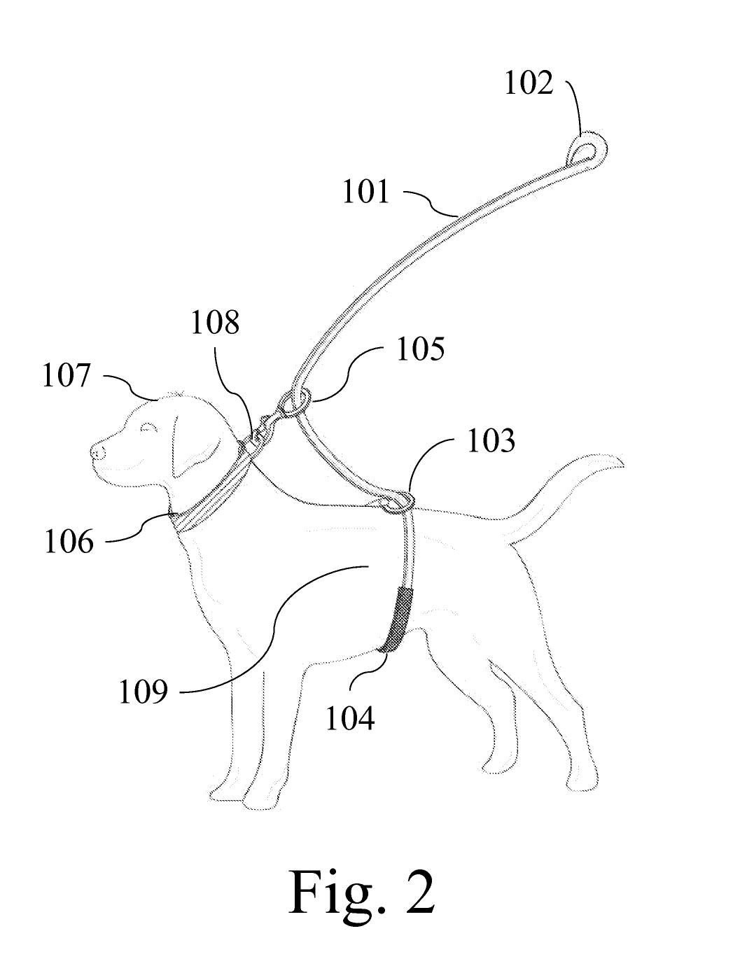

Now referring to FIG. 2, the leash 100 of the present invention is illustrated as it would be worn by a dog or other similar animal 107. The leash 100 is placed onto the animal by first wrapping the rope 101 portion containing the foam piece 104 around the belly of the animal 107. Next, the handle 102 and sliding hook 105 are slid through the O-ring 103 located at the opposing end of the handle 102. The sliding hook 105 is then clipped on to a d-ring 108 or other area of the pet's collar .106 A user can, and should, adjust the foam piece 104 around the animal 107 to reduce strain and minimize the change of injury to the animal 107. The leash 100 works by retracting when the pet or animal 107 pulls against it. When the pet or animal 107 pulls on the leash 100, the sliding hook 105 allows the leash rope 101 to retract around the belly 109 and also pulls the head back 110. The resulting pulling of the head 110 in combination with the pressure of the tightening rope 101 around its belly 109 causes the animal 107 to stop pulling quickly. The result is a fast and humane way of controlling and stopping the animal 107 which greatly minimizes the potential for injury.

Additionally, the leash 100 of the present invention does not require a plurality of latches, hooks, or other fasteners as other devices taught in the prior art. The leash 100 of the present invention is novel and non-obvious over the prior art because it requires much less parts, resulting in a device that is easier to use, more cost effective to produce, and provides control of an animal 107 in a safe way with a greatly reduced chance of injury.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A leash device for controlling an animal comprising in combination:
a rope;
a handle on a first end of the rope;
an o-ring on an opposing end of the rope from the handle;
a foam piece provided between the handle and o-ring providing cushion between the rope and an animal wearer's belly region;
a sliding hook located between the handle and foam piece;
the sliding hook connecting to an animal's collar; and
the hook slides on the rope of the leash and is easily moved along the rope to fit a variety of animals of varying shapes and sizes.

2. The device of claim 1, wherein the rope is comprised of nylon.

3. The device of claim 1, wherein the foam piece prevents injury, rubbing, and similar injuries that could be result from wearing or over use of the device.

4. The device of claim 1, wherein the sliding hook allows the leash to connect to an animal's traditional collar, when the leash is worn by the animal.

5. The device of claim 1, wherein the sliding hook slides on the rope of the leash and is easily moved along the rope to fit a variety of animals of varying shapes and sizes.

6. An apparatus for controlling an animal comprising:
a leash worn by an animal;
the leash comprised of:
a rope;
a handle on a first end of the rope;
an O-ring on an opposing end of the rope from the handle;
a foam piece provided between the handle and O-ring providing cushion between the rope and an animal wearer's belly region; and
a sliding hook located between the handle and foam piece;
the leash placed onto the animal by first wrapping the rope portion containing the foam piece around the belly of the animal;
the handle and sliding hook are slid through the O-ring located at the opposing end of the handle;
the sliding hook is then clipped on to the animal's collar;
adjusting the foam piece around the animal to reduce strain and minimize the change of injury to the animal;

8. The apparatus of claim 7, wherein the rope retracts when the pet or animal pulls against it.

9. The apparatus of claim 7, wherein the when animal pulls on the leash, the sliding hook allows the leash rope to retract around the belly and also pulls the head back.

10. The apparatus of claim 7, wherein the sliding hook is then clipped on to a d-ring on the animal's collar.

11. The device of claim 7, wherein the rope is comprised of nylon.

12. The device of claim 7, wherein the foam piece prevents injury, rubbing, and similar injuries that could be result from wearing or over use of the device.

13. The device of claim 7, wherein the sliding hook allows the leash to connect to an animal's traditional collar, when the leash is worn by the animal.

14. The device of claim 7, wherein the sliding hook slides on the rope of the leash and is easily moved along the rope to fit a variety of animals of varying shapes and sizes.
